(19) United States
(12) Patent Application Publication
(10) Pub. No.: US 2004/0095258 A1
(43) Pub. Date: May 20, 2004

(54) Detecting the presence of a vehicle with a particular vehicle registration number

(76) Inventors: Johannes Brits Bosch, Constantia (ZA); Hendrik Albertus Cronje, Alberton (ZA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/221,629

(22) PCT Filed: Mar. 13, 2001
(86) PCT No.: PCT/IB01/00350

(30) Foreign Application Priority Data
Mar. 14, 2000 (ZA) 2000/1301

(51) Int. Cl. G08G 1/017

(52) U.S. Cl. 340/937

(57) ABSTRACT

A detection device (100) for detecting the presence of a vehicle with a particular vehicle registration number in a monitored zone is provided. The device includes database storage means (118) for storing a database comprising the vehicle registration number of at least one vehicle which it is desired to detect, image capturing means (102) for capturing an optical image of the monitored zone at least when a vehicle is present in the monitored zone, processing means (116) configured to process the optical image to obtain the captured vehicle registration number and to compare the captured vehicle registration number with vehicle registration numbers in the database, and alarm means (122, 18) for generating an alarm signal if the captured vehicle registration number corresponds with the vehicle registration number of any vehicle in the database which it is desired to detect.

THIS INVENTION relates to detecting the presence of a vehicle with a particular vehicle registration number. In particular, it relates to a detection device for detecting the presence of a vehicle with a particular vehicle registration number in a monitored zone, to a method of detecting the presence of a vehicle with a particular vehicle registration number in a monitored zone, and to a system for locating a vehicle with a particular vehicle registration number.

According to one aspect of the invention, there is provided a detection device for detecting the presence of a vehicle with a particular vehicle registration number in a monitored zone, the device including

database storage means for storing a database comprising the vehicle registration number of at least one vehicle which it is desired to detect;

image capturing means for capturing an optical image of the monitored zone at least when a vehicle is present in the monitored zone, the optical image including at least an optical image of the registration number of at least one vehicle in the monitored zone;

processing means configured to process the optical image to obtain the captured vehicle registration number and to compare the captured vehicle registration number with vehicle registration numbers in the database; and

alarm means for generating an alarm signal if the captured vehicle registration number corresponds with the vehicle registration number of any vehicle in the database which it is desired to detect.

The alarm means may include a sound generating device for generating an audible alarm.

The alarm means may include transmitting means for transmitting the alarm signal to a location remote from the detection device, e.g. a control room or a mobile vehicle reaction unit. The transmitting means may thus include a transmitter configured to transmit the alarm signal in a wireless communication fashion or over a wireless communications link to the remote location.

The transmitter may be configured to transmit the alarm signal over a digital cellular network such as CDPD, CDMA, GSM, PDC, PHS, TDMA, FLEX, ReFLEX, IDEN, TETRA, DECT, DataTAC or Mobitex. Instead, the transmitter may be configured to transmit the alarm signal to an earth orbiting satellite. In one embodiment of the invention, the transmitter is configured to transmit the alarm signal using a Short Message Service (SMS) facility of a digital cellular network.

Preferably, when the transmitter is configured to transmit the alarm signal over a digital cellular network, the transmitter is compliant with the Wireless Application Protocol (WAP).

The alarm means may be configured to include in the alarm signal information selected from the group consisting of the location of the detection device, the vehicle registration number in the database which corresponds with the registration number of the vehicle in the monitored zone, the time at which the vehicle was detected in the monitored zone, the direction of travel of the vehicle in the monitored zone, and two or more of these. In some embodiments of the detection device of the invention, it may also be possible to include the captured optical image of the monitored zone, and thus typically an image of the vehicle carrying the captured vehicle registration number, in the alarm signal.

The detection device may include database access means for accessing or manipulating a database stored on the database storage means. The database access means may allow access to or manipulation of the database from a location remote from the detection device, e.g. to add or delete records to the database.

The database access means may be configured to receive information or instructions over a communication path or link or protocol selected from the group consisting of a local area network (LAN), a digital cellular network data link, a digital cellular network Short Message Service, a radio frequency link, an earth-orbiting satellite link, and two or more of these. The database access means may thus include a receiver. Preferably, when a receiver is present and configured to receive data over a digital cellular network, the receiver is compliant with the Wireless Application Protocol.

The image capturing means may include a digital video camera or a digital still camera. Instead, the image capturing means may include an analogue video camera and a frame grabber. The camera may be configured to use multiple lenses.

The camera may be a black and white camera and may have a spectral sensitivity in the range of 400 nm to 1100 nm.

The image capturing means may include a light sensor connected to the camera for adjusting camera settings.

The image capturing means may include a catodioptric lens, typically but not necessarily exclusively for capturing images of vehicles travelling at more than 60 km/h, or even more than 100 km/h, e.g. between 120 km/h and 180 km/h. The catodioptric lens may have an effective focal length of between 300 mm and 320 mm e.g. 305 mm and the catodioptric lens may be fitted with an infra red (IR) or high-pass filter, e.g. a filter that is transparent above 695 nm.

The image capturing means may include a refractive lens, typically but not necessarily exclusively for capturing images of vehicles travelling at 60 km/h or less. The refractive lens may have a focal length of between 5 mm and 50 mm and the refractive lens may be fitted with an infra red (IR) (high-pass) filter.

The detection device may include triggering means for triggering the image capturing means to capture an optical image of the monitored zone only when a vehicle is present in the monitored zone and preferably each time a vehicle is present in the monitored zone. The triggering means may be selected from the group consisting of a static triggering means, a pressure triggering means, a proximity triggering means, a motion detection triggering means, a laser/optical detection triggering means, a manual triggering means, and two or more of these. An example of a static triggering means is a triggering means based on the piezo-electric effect that occurs when a force is applied to a combination of a dielectric material and a metal conductor. An example of a pressure triggering means is a pneumatic sensor fitted to a flexible hose over which a vehicle moves. Examples of proximity trigger means include triggering means based on the Hall effect, magnetic induction, ultrasonic detection and IR optical detection. Motion the detection triggering means may be based on a change in the content of the captured optical images (digital or analogue) as captured or recorded by, for example, a CCD or a CMOS. The triggering means may then include a processor configured to monitor the recorded or captured images on a continuous basis and to generate a trigger signal based on any change in image frame content between two successive frames. An example of a laser/optical detection triggering means, is a trigger based on the interruption of a light beam between an optical transmitter and an optical detector. As will be appreciated, a manual triggering means requires the presence of an operator to trigger the detection device manually when desired.

The detection device may include a light source for illuminating a vehicle in the monitored zone. The light source may emit light in the spectral range of 800 nm to 950 nm.

The processing means may include a conventional CPU and motherboard and may be operated with any conventional operating system such as Linux, Unix, Windows NT, AS400, OS2, and DOS. Some or all of these operating system names may be trade marks.

The processing means may include one or more programs or algorithms to identify a region of the captured optical image where the registration number is most likely to be located and to perform an optical character recognition operation only on said region of the captured optical image. The processing means may also include one or more programs or algorithms to process the captured optical image to obtain an image more suitable for a character recognition operation prior to obtaining the captured vehicle registration number. Furthermore, the processing means may include one or more programs or algorithms to compress data for increased transmission speeds (for example, spacial or temporal compression may be used) and to maintain and manage any database stored on the database storage means.

The processing means may use any suitable conventional algorithm or software to perform an optical character recognition operation on the optical image of the captured vehicle registration number. The software may make use of methods such as mask/template matching, stroke analysis, neural networking, or combinations of these.

The database of the detection device of the invention may be maintained and managed by any conventional database software, such as MSAccess (trade mark), Oracle (trade mark), or the like. The processor may include an indexing program to allow for fast searches of the database. Data in the database may be encrypted.

The detection device may include one or more programs or algorithms to test the functionality of the detection device, to control the image capturing means, and to control any communication functions. These programs or algorithms may be operable by the processing means.

The detection device may include a power source such as a battery, and may thus be mobile. Instead, or in addition, the detection device may include a solar panel, or it may be powered by electricity drawn from a power grid or a generator.

The detection device may include a battery charger when it is battery operated and an Uninterrupted Power Supply (UPS) which can also function as an invertor.

Typically, the database includes a plurality of vehicle registration numbers, e.g. a list of the vehicle registration members of stolen or hi-jacked vehicles. The database may also include information on the colour, make and model of each listed vehicle, and information on the value of each listed vehicle if it is a stolen or hi-jacked vehicle. The information on the value of each listed stolen or hijacked vehicle can be used to prioritise the generation of alarm signals by the alarm means, if desired. For example, if a vehicle has a high value or a high insurance company pay-out ratio, the presence of the vehicle in the monitored zone may be reported first in preference to a vehicle with a lower value or a lower insurance company pay-out ratio.

According to another aspect of the invention, there is provided a method of detecting the presence of a vehicle with a particular vehicle registration number in a monitored zone, the method including

capturing an optical image of the monitored zone at least when a vehicle is present in the monitored zone, the optical image including at least an optical image of the registration number of at least one vehicle in the monitored zone;

recognizing the captured vehicle registration number;

comparing the vehicle registration number with a database which includes the registration numbers of vehicles which it is desired to detect; and

generating an alarm signal if the captured vehicle registration number corresponds with one of the vehicle registration numbers in the database which it is desired to detect, thereby signalling that the presence of the vehicle with said particular vehicle registration number was detected in the monitored zone.

The monitored zone may include multiple lanes of a road.

The capturing of the optical image of the monitored zone may be effected with image capturing means as hereinbefore described.

The method may include transmitting the alarm signal to a location remote from the detection device. The alarm signal may be transmitted in a wireless communication fashion or over a wireless communications link or path to the remote location, as hereinbefore described.

In one embodiment of the invention, the alarm signal is transmitted using a Short Message Service (SMS) facility of a digital cellular network.

The alarm signal may include information selected from the group consisting of the location of the monitored zone, the registration number of the vehicle registration number in the database which corresponds with the vehicle in the monitored zone, the time at which the vehicle was detected in the monitored zone, the direction of travel of the vehicle in the monitored zone, and two or more of these.

The recognizing of the captured vehicle registration number may be effected by any suitable algorithm or software operating on a microprocessor or CPU.

The method may include accessing or manipulating the database when required, e.g. to update the database. Updating the database may include adding and/or deleting vehicle registration numbers from the database. The database may be accessed or manipulated from a location remote from the database.

The database may be accessed or manipulated over a communication path or link or protocol selected from the group consisting of a local area network (LAN), a digital cellular network data link, a digital cellular network Short Message Service, a radio frequency link, an earth-orbiting satellite link, and two or more of these.

The vehicle in the monitored zone may be travelling at a speed of more than 60 km/h, or even more than 100 km/h, e.g. between 120 km/h and 180 km/h.

The method may include capturing the optical image of the monitored zone only when a vehicle is present in the monitored zone and preferably each time a vehicle is present in the monitored zone.

The method may include illuminating a vehicle in the monitored zone with light in the spectral range of 800 nm to 950 nm.

The method may include identifying a region of the captured optical image where the registration number is most likely to be located and performing an optical character recognition operation only on said region of the captured optical image.

The method may include processing the captured optical image to obtain an image more suitable for a character recognition operation, prior to performing an optical character recognition operation to recognize the captured vehicle registration number.

According to a further aspect of the invention, there is provided a system for locating a vehicle with a particular vehicle registration number, the system including

at least one detection device as hereinbefore described; and

at least one monitoring station for monitoring alarm signals from the detection device.

Preferably, the system includes a plurality of detection devices. Each detection device may be located at a different location, e.g. at a location where it can monitor a portion of a busy road or an intersection or at access control points such as corporate buildings, taxi ranks, toll gates, border posts, and the like.

The system may include a central database or data warehouse. The central database may be updated when required, e.g. over the Internet. Data may then be transmitted to the or each detection device from the central database.

The or each monitoring station may thus include transmitting means for transmitting data to the or each detection device.

The transmitting means may be configured to transmit data to the or each detection device over a communication path or link or protocol selected from the group consisting of a local area network (LAN), a digital cellular network data link, a digital cellular network Short Message Service, a radio frequency link, an earth-orbiting satellite link, and two or more of these.

The system may include one or more mobile reaction units which can respond to instructions from the monitoring station, or on receipt of an alarm signal from a detection device. Thus, each mobile reaction unit may include receiving means for receiving an alarm signal from a detection device.

The invention will now be described, by way of example, with reference to the accompanying diagrammatic drawings, in which

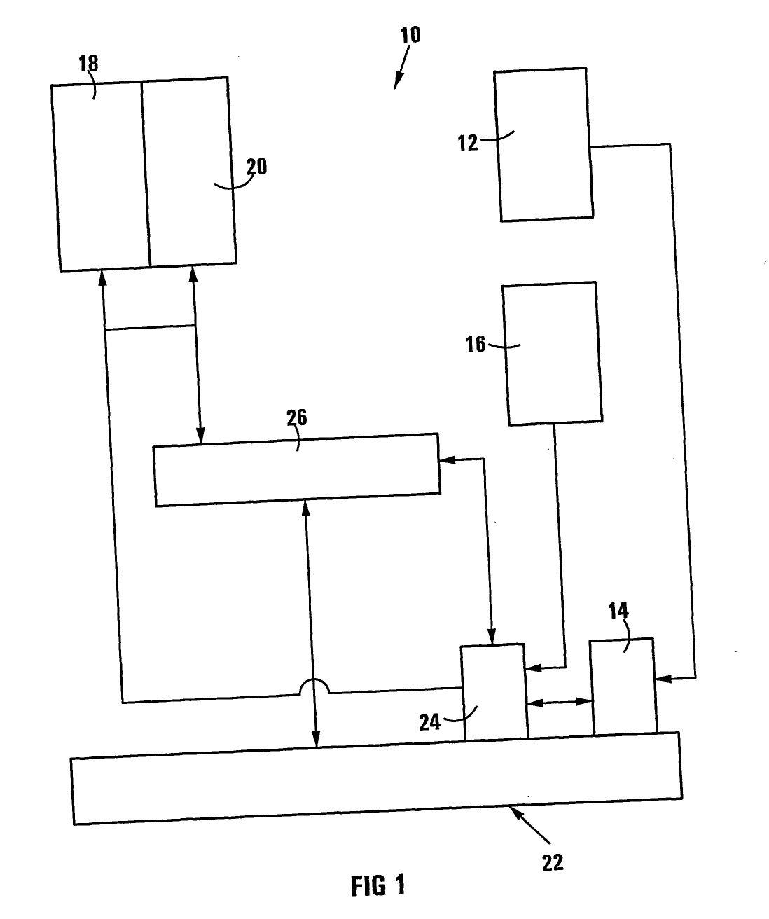

FIG. 1 shows a basic functional block diagram of a detection device in accordance with the invention for detecting the presence of a vehicle with a particular vehicle registration number in a monitored zone;

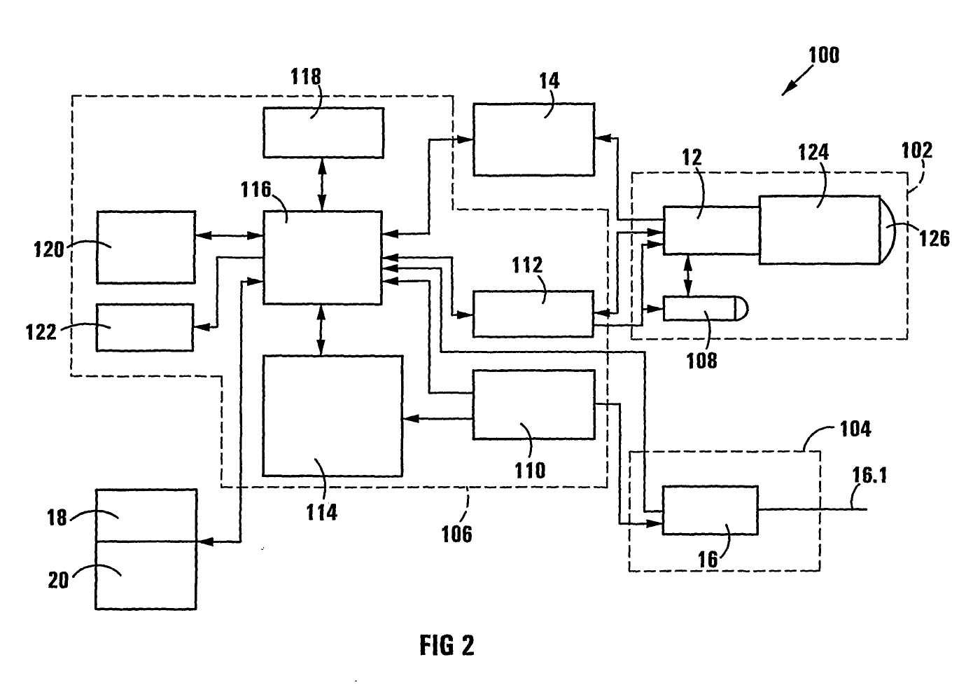

FIG. 2 shows a more detailed functional block diagram of another embodiment of a detection device in accordance with the invention for detecting the presence of a vehicle with a particular vehicle registration number in a monitored zone; and

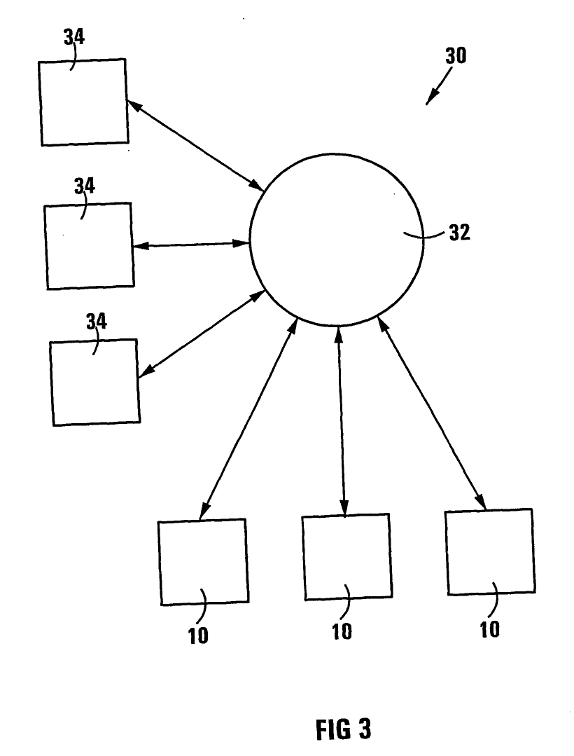

FIG. 3 shows a functional block diagram of a system in accordance with the invention for locating a vehicle with a particular vehicle registration number.

Referring to FIG. 1 of the drawings, reference numeral 10 generally indicates a device in accordance with the invention suitable for detecting the presence of a vehicle with a particular vehicle registration number in a monitored zone.

The device 10 is a basic concept version or prototype embodying aspects of the invention and a commercial embodiment is likely to differ in at least some respects from the device 10. The device 10 is battery powered, with the option of drawing electrical power from a power supply grid, and includes image capturing means comprising a video camera 12 and a frame grabber card 14, triggering means in the form of a proximity switch 16 for triggering the video camera 12, alarm means which includes a transmitter 18, database access means which includes a receiver 20, further associated hardware generally indicated by reference numeral 22 which includes at least one controller card 24, a mother-board with slots for the controller cards, a harddrive, a power supply unit, a cooling fan and a central processing unit (CPU). Software, residing on the harddrive and operable on the central processing unit, is generally indicated by reference numeral 26.

The video camera 12 is a high resolution video camera with a high shutter speed. The camera is a black and white camera, but it is foreseen that the camera can also be a colour camera. The camera can receive different lenses, e.g. a 35 mm refractive lens or a 305 mm catodioptric lens, to cater for different monitoring conditions.

The frame grabber card 14 is a conventional frame grabber card. The frame grabber card 14 is slotted into one of the slots on the mother-board and receives a video image from the video camera 12.

The proximity switch 16 is a conventional proximity switch which can sense the presence of a vehicle up to a reasonable distance. The proximity switch 16 is in communication with the controller card 24 and via the controller card 24 with the frame grabber card 14.

The transmitter 18 is configured to transmit an alarm signal over a GSM digital cellular network. The transmitter 18 is compliant with the Wireless Application Protocol and is configured to transmit data using the Short Message Service (SMS) provided by a GSM digital cellular network service provider.

The receiver 20 is configured to receive data over the GSM digital cellular network. The receiver is also compliant with the Wireless Application Protocol and can receive data using the Short Message Service (SMS) provided by the GSM digital cellular network service provider.

As will be appreciated, any transmitter/receiver combination hardware compatible with a GSM digital cellular network and capable of communicating with the CPU may be used. Examples of such hardware is a Siemens M2O cellular telephone, an Alcatel One Touch Easy cellular telephone, a Wavecom cellular telephone, or the like.

The software 26 includes a conventional database program which maintains an encrypted database with a list of “hot” vehicle registration numbers, e.g. stolen or hijacked or deregistered vehicle registration numbers, together with further information such as the colour, make and model of each vehicle whose number is captured in the database. The database can be remotely updated by means of data received by the receiver 20.

The software 26 also includes an optical character recognition program capable of recognizing vehicle registration numbers from optical images of vehicles. A conventional commercially available program can be used. Typically, such programs make use of mask/template matching, stroke analysis, neural networking or a combination of these methods.

The software 26 also includes an indexing program to allow for fast searches of records in the database, and a program for recording images passed on to the program from the frame grabber card 14 for presenting to the optical character recognition program. The software 26 also includes a compression program to extract and compress data or information for data transfer, and an operating system, such as Linux, Unix, Windows NT, AS400 or OS2, to run the programs.

The device 10 is mobile and includes a weather-proof housing (not shown) for housing all the hardware and software. The device 10 also includes an Uninterrupted Power Supply (UPS) (not showri) for backup purposes.

In use, the device 10 is placed such that it can monitor a portion of a busy road and is then activated. The video camera 12 continuously monitors a portion of the road, which thus defines a monitored zone. The proximity switch 16 activates the frame grabber card 14, via the controller card 24, to grab or capture an optical image of the monitored zone, provided by the video camera 12, only when a vehicle is present in the monitored zone and each time a vehicle is present in the monitored zone.

The optical character recognition software processes the optical image captured by the frame grabber card 14 and recorded by the recording program, in an attempt to recognize the vehicle registration number of the vehicle present in the monitored zone. If the vehicle registration number is recognized or determined by the optical character recognition software, the indexing software searches the database and compares the captured vehicle registration number with all the listed vehicle registration numbers in the database. If a match is found, an alarm signal is generated and transmitted via the transmitter 18 over the GSM digital cellular network to a party or entity intended to receive the alarm signal. The alarm signal typically includes the detected vehicle registration number and the location of the device 10. If desired, the alarm signal can also include information on the direction of travel of the vehicle whose registration number was captured and the time at which the vehicle was detected in the monitored zone.

In order to update the database, data is sent over the GSM digital cellular network to the receiver 20 which passes the data on to the database. Thus, the database can be updated with the vehicle registration numbers of more stolen or hijacked vehicles or deregistered vehicles or the like, or the vehicle registration numbers of recovered vehicles can be deleted from the database.

If it is desired to monitor a different road or intersection, the device 10 is simply relocated to a new location, the database is updated with the location of the device 10, and the device 10 is activated to monitor a particular zone.

Referring to FIG. 2 of the drawings, reference numeral 100 generally indicates another embodiment of a detection device in accordance with the invention for detecting the presence of a vehicle with a particular vehicle registration number in a monitored zone. The detection device 100 illustrates a working embodiment of the invention and it is expected that a commercial version of the detection device of the invention will differ in only a few aspects from the detection device 100.

For ease of reference and understanding, in the block diagram, an optical unit 102, a trigger unit 104 and a data processing unit 106 are indicated. However, the detection device 100 is similar to the detection device 10, and unless otherwise indicated, the same reference numerals are used to indicate the same or similar parts or features. Thus, the detection device 100 includes a black and white analogue video camera 12 with a spectral sensitivity of between 400 nm and 1100 nm, a frame grabber card 14 and triggering means 16 with a pressure sensor 16.1.

The detection device 100 further includes a light meter 108, a power supply 110, a serial communication device 112, a display screen 114, a central processing unit (CPU) 116 with memory, a data storage device in the form of a harddrive 118, a local area network (LAN) device or card 120 and alarm means which includes a sound generator 122, and a communication device comprising a transmitter 18 and a receiver 20.

The optical unit 102 includes a lens 124 and an IR filter 126. When the detection device 100 is intended to monitor a zone through which vehicles move slowly, the lens 124 is a 5 to 50 mm refractive lens with an appropriate focal length for the distance between the optical unit 102 and the vehicle whose image is to be captured. For high speed applications, i.e. for use of the detection device 100 to capture images of fast moving vehicle, the lens 124 is a catodioptric lens with an effective focal lens of 305 mm. The IR filter 126 may be any suitable filter, such as a Shott Glass RG695 IR filter. As is thus readily apparent, the detection device 100 can be used in a high speed configuration and a low speed configuration. To change between the two configurations, the optics are simply changed and the triggering means 16 is repositioned so that the monitored zone is further or closer to the optics, as the case may be.

The light meter 108 is an ambient light meter and is used to determine the light level at the scene to be captured by the camera 12 as well as the ambient light level. This information is transmitted to the CPU 116 through the serial communication device 112, which is an RS232C communications device.

Although not shown in FIG. 2 of the drawings, the detection device 100 also includes a strobe or flash unit which may be situated at a preselected distance from vehicles whose image is to be captured. The light emitted from the strobe/flash unit falls in the spectral range of 800 to 950 nm. This is in the near IR range and falls outside the human visible spectrum and will consequently not affect the human vision when the strobe is activated.

The data processing unit 106 comprises a standard PC based industrial computer fitted with the frame grabber card 14 and comprising the harddrive 118 and memory (not shown), in addition to a motherboard (not shown), a liquid crystal display (LCD) driver (not shown), the LAN connecting device 120 and with audio capacity. Typically, the CPU 116 uses the Linux operating system, but as will be appreciated, any other suitable operating system may be used.

The frame grabber card 14 is a standard PCI frame grabber card. It accepts an analogue video signal that conforms to either the PAL or the NTSC standard. The frame grabber card 14 is fully controllable via software operating on the CPU 116. The frame grabber card 14 is equipped with a trigger input that conforms to standard TTL logic levels. This trigger is polled by optical character recognition software operating on the CPU 116 and when activated in use the next complete frame is digitized and stored in the memory of the computer.

The software operating on the CPU 116 includes a built-in test (BIT) routine, a plurality of house-keeping routines, a database management functionality, a camera control functionality, an image pre-processing functionality, an optical character recognition functionality, and a communications functionality.

The built-in test routines are executed during an initialization phase of the detection device 100. The software tests for the presence of an active video feed, tests the communications to and from the camera 12 as well as any communication links, and logs all test results in a log file that is available for later inspection.

The house-keeping routines of the software is responsible for the performing of all functions relating to the proper operation of the detection device 100, i.e. it manages the storage of recorded images, image compression, polling of the trigger means 16, and the like.

Similar to the detection device 10, the detection device 100 hosts an encrypted database with a list of “hot” vehicle registration numbers. The database management functionality ensures the capability to update the database via the receiver 20 or via the LAN connecting device 120. Furthermore, the database management functionality allows searches of the database using a vehicle registration number obtained from a captured digital image.

The camera control functionality allows control of the settings of the camera 12. Control commands are sent to the camera 12 via the RS232C serial communication device 112. The camera control commands are determined by the software and are based on information obtained from the light meter 108 as well as from information extracted from the digital image provided by the camera 12. The camera control functionality is capable of setting the exposure time or shutter speed of a camera, an electronic iris, a gamma value and an automatic gain.

The image pre-processing functionality allows pre-processing of an image grabbed by the frame grabber card 14 to obtain an image that is better suitable for character recognition operations. Typically, the image pre-processing functionality allows shifting of the contrast of the image, removing colour components, removing odd or even frames from an image, and the like.

The character recognition functionality is configured to analyse a digital image captured by the frame grabber card 14 in order to locate a region of the image where a number plate is most likely to be located. Once such a region is identified, the software analyses the region for alphanumeric characters. The software typically employs neural networking techniques, template matching, mask-matching, stroke analysis and Fourier descriptors to achieve its objective.

The communications functionality allows updating of the vehicle database via the LAN connecting device 120 or the receiver 20. Any suitable message format may be used, such as Extensible Mark-up Language (XML), Transmission Control Protocol/Internet Protocol (TCP/IP), and Unix to Unix Copy (UUCP). The communications functionality also allows for the transmission of an alarm signal, typically via the transmitter 18 which is typically configured to transmit the alarm signal using the Short Message Service (SMS) of a digital cellular network.

The detection device 100 includes a welded aluminium case (not shown) for housing most of the sub-components of the protection device 100 and which serves as a carry for the optical unit 102 and connecting cables. A lid of the case houses the display screen 114. All connectors are fitted on recessed mountings to prevent damage during transport and handling and the harddrive 118 is mounted on shock mounts to prevent physical damage during handling and transit. The optical unit 102 is housed in a weather-proof housing in order to protect the optics and the camera 12 from the elements. The housing has a clear aperture which accommodates the wide angle optics of the refractive lens, when it is present. The clear cover is manufactured from plate glass and does not have any visible defects. It is at least 95% transparent in the 550 nm to 1100 nm range.

The detection device 100 has five modes of operation, namely an initialization mode, a normal operation mode, a manual mode, a maintenance mode and a failure mode.

The detection device 100 enters the initialization mode automatically when power is supplied to the device 100. During this mode the detection device 100 performs a built-in test, which includes standard bios self-tests and further tests for the presence of an active video feed and data communications link. During the data link test, the detection device 100 transmits an initialization message to a command station (which is further discussed below). The initialization message indicates to the command station that the protection device 100 is operational and thus tests the integrity of the communications link. In the event that any of the tests fail, the detection device 100 enters the failure mode. However, on successful completion of the built-in test, the detection device 100 enters the normal operation mode.

During the normal operation mode, the detection device 100 displays a standard graphical user interface on the display screen 114. The graphical user interface enables an operator to position the camera 12 to cover the desired monitored zone. During the normal operation mode, the detection device 100 monitors the state of the trigger means 16. This can be achieved by either polling a trigger port to test the state of the trigger means 16 or the CPU 116 can act on the reception of an interrupt signal from the trigger port. Video information is fed on a continuous basis from the camera 12 to the display screen 114. When the trigger 16 generates a trigger signal, a video frame from the frame grabber 14 is committed to the memory of the detection device 100 and the information is transferred to the harddrive 118 for storage. Typically, the detection device 100 (and 10) is set up to obtain an image of the front of a vehicle in the monitored zone. The software operating on the CPU 116 then preprocesses the image to optimize the image for character recognition, performs the optical character recognition operation on the processed image, and displays the result on the graphical user interface on the display screen 114. A search is then automatically conducted of the database in an attempt to find a match in the database for the vehicle registration number captured and recognised. In the case of a match, an audible alarm is sounded by the sound generator 122, relevant data is extracted from the database and displayed on the graphical user interface, and an alarm signal is transmitted via the transmitter 18 to a party or entity intended to receive the alarm signal.

The manual mode is a sub-mode of the normal operation mode and is an operator selected mode. This mode does not affect the normal mode of operation which is still functioning in the background. During the manual mode, the operator is able to perform manual queries in the database to verify vehicle number plates or other information contained in the database. The detection device 100 returns to the normal operation mode if the operator enters a command to that effect, or after an elapsed time of 120 seconds of inactivity on the part of the operator. If an error occurs during the manual mode, the detection device 100 enters the failure mode automatically.

The maintenance mode of the detection device 100 is intended to be used by service personnel only. This mode is used for updating the database and for downloading images stored on the harddrive 118. The maintenance mode is elected by either commanding the detection device 100 to enter the maintenance mode from the normal operation mode, by means of a security code, or remotely via a communications link. Typically, the maintenance mode is entered on a remote instruction via a communications link in order to perform maintenance of the database. The maintenance mode can thus run in the background and does not affect the normal operation mode. On completion of the maintenance task, the detection device 100 closes the communications link without affecting the normal operations of the detection device 100. This last action is completely transparent to an operator of the detection device 100.

When the detection device 100 enters the failure mode, the graphical user interface indicates the type of failure on the display screen 114. An operator can then attempt to solve any problems by taking appropriate action. The detection device 100 can only exit the failure mode by cycling the power. All failures are logged in a log file for later analysis.

Referring to FIG. 2 of the drawings, a system in accordance with the invention for locating a vehicle with a particular vehicle registration number is generally indicated by reference numeral 30.

The system 30 includes a command station 32, a plurality of monitoring devices 10 or 100 as hereinbefore described, only three of which are shown, and a plurality of mobile vehicle reaction units 34, only three of which are shown.

The command station 32 has data transmitting and receiving capabilities for transmitting and receiving data over a GSM digital cellular network and a LAN. Thus, the command station 32 can receive alarm signals from all the devices 10 (or 100), and can transmit data to each device 10 (or 100). The command station 32 updates the database in each detection device 10 (or 100) as and when required, by means of a communications data link. In the embodiment shown, that is by either the LAN or by using the digital cellular network.

Each mobile vehicle reaction unit 34 is in wireless communication with the command station 32 and can receive instructions from the command station 32. In some embodiments of the system of the invention, the mobile vehicle reaction units 34 are also in direct communication with the devices 10 (or 100) using the GSM digital cellular network.

When one of the devices 10 (or 100) signals that a listed stolen or hijacked vehicle was detected, the alarm signal is transmitted to the command station 32, which can direct one or more of the mobile vehicle reaction units 34 in the direction and towards the location where the vehicle was noticed. When the mobile vehicle reaction units 34 are directly in communication with the devices 10 (or 100), they may be even faster to react to an alarm signal than when the alarm signal is communicated via the command station 32.

It is believed that an advantage of the device 10, 100 as illustrated, is that it is mobile and that it makes use of existing digital cellular networks for data transmission and reception.

1. A detection device for detecting the presence of a vehicle with a particular vehicle registration number in a monitored zone, the device including
database storage means for storing a database comprising the vehicle registration number of at least one vehicle which it is desired to detect;
image capturing means for capturing an optical image of the monitored zone at least when a vehicle is present in the monitored zone, the optical image including at least an optical image of the registration number of at least one vehicle in the monitored zone;
processing means configured to process the optical image to obtain the captured vehicle registration number and to compare the captured vehicle registration number with vehicle registration numbers in the database; and
alarm means for generating an alarm signal if the captured vehicle registration number corresponds with the vehicle registration number of any vehicle in the database which it is desired to detect.

2. A detection device as claimed in claim 1, in which the alarm means includes transmitting means for transmitting the alarm signal to a location remote from the detection device.

3. A detection device as claimed in claim 2, in which the transmitting means includes a transmitter configured to transmit the alarm signal in a wireless communication fashion to the remote location.

4. A detection device as claimed in claim 3, in which the transmitter is configured to transmit the alarm signal using a Short Message Service (SMS) facility of a digital cellular network.

5. A detection device as claimed in any one of the preceding claims, in which the alarm means is configured to include in the alarm signal information selected from the group consisting of the location of the detection device, the vehicle registration number in the database which corresponds with the registration number of the vehicle in the monitored zone, the time at which the vehicle was detected in the monitored zone, the direction of travel of the vehicle in the monitored zone, and two or more of these.

6. A detection device as claimed in any one of the preceding claims, which includes database access means for accessing or manipulating a database stored on the database storage means.

7. A detection device as claimed in claim 6, in which the database access means allows access to or manipulation of the database from a location remote from the detection device.

8. A detection device as claimed in claim 6 or claim 7, in which the database access means is configured to receive information or instructions over a communication path or protocol selected from the group consisting of a local area network (LAN), a digital cellular network data link, a digital cellular network Short Message Service, a radio frequency link, an earth-orbiting satellite link, and two or more of these.

9. A detection device as claimed in any one of the preceding claims, in which the image capturing means includes a digital video camera or a digital still camera.

10. A detection device as claimed in any one of claims 1 to 8 inclusive, in which the image capturing means includes an analogue video camera and a frame grabber.

11. A detection device as claimed in claim 9 or claim 10, in which the camera is a black and white camera with a spectral sensitivity in the range of 400 nm to 1100 nm.

12. A detection device as claimed in any one of claims 9 to 11 inclusive, in which the image capturing means includes a light sensor connected to the camera for adjusting camera settings.

13. A detection device as claimed in any one of claims 9 to 12 inclusive, in which the image capturing means includes a catodioptric lens for capturing images of vehicles travelling at more than 60 km/h.

14. A detection device as claimed in claim 13, in which the catodioptric lens has an effective focal length of between 300 mm and 320 mm and in which the catodioptric lens is fitted with an infra red (IR) or high-pass filter.

15. A detecting device as claimed in any one of claims 9 to 14 inclusive, in which the image capturing means includes a refractive lens for capturing images of vehicles travelling at 60 km/h or less.

16. A detection device as claimed in claim 15, in which the refractive lens has a focal length of between 5 mm and 50 mm and in which the refractive lens is fitted with an infra red (IR) or high-pass filter.

17. A detection device as claimed in any one of the preceding claims, which includes triggering means for triggering the image capturing means to capture an optical image of the monitored zone only when a vehicle is present in the monitored zone and each time a vehicle is present in the monitored zone.

18. A detection device as claimed in any one of the preceding claims, which includes a light source for illuminating a vehicle in the monitored zone, the light source emitting light in the spectral range of 800 nm to 950 nm.

19. A detection device as claimed in any one of the preceding claims, in which the processing means includes one or more programs or algorithms to identify a region of the captured optical image where the registration number is most likely to be located and to perform an optical character recognition operation only on said region of the captured optical image.

20. A detection device as claimed in any one of the preceding claims, in which the processing means includes one or more programs or algorithms to process the captured optical image to obtain an image more suitable for a character recognition operation prior to obtaining the captured vehicle registration number.

21. A detection device as claimed in any one of the preceding claims, in which the processing means includes one or more programs or algorithms to compress data for increased transmission speeds and to maintain and manage any database stored on the database storage means.

22. A detection device as claimed in any one of the preceding claims, which includes one or more programs or algorithms to test the functionality of the detection device, to control the image capturing means, and to control any communication functions.

23. A detection device as claimed in any one of the preceding claims, which is mobile.

24. A method of detecting the presence of a vehicle with a particular vehicle registration number in a monitored zone, the method including
capturing an optical image of the monitored zone at least when a vehicle is present in the monitored zone, the optical image including at least an optical image of the registration number of at least one vehicle in the monitored zone;
recognizing the captured vehicle registration number;
comparing the vehicle registration number with a database which includes the registration numbers of vehicles which it is desired to detect; and
generating an alarm signal if the captured vehicle registration number corresponds with one of the vehicle registration numbers in the database which it is desired to detect, thereby signalling that the presence of the vehicle with said particular vehicle registration number was detected in the monitored zone.

25. A method as claimed in claim 24, which includes transmitting the alarm signal to a location remote from the detection device.

26. A method as claimed in claim 25, in which the alarm signal is transmitted in a wireless communication fashion to the remote location.

27. A method as claimed in claim 26, in which the alarm signal is transmitted using a Short Message Service (SMS) facility of a digital cellular network.

28. A method as claimed in any one of claims 24 to 27 inclusive, in which the alarm signal includes information selected from the group consisting of the location of the monitored zone, the registration number of the vehicle registration number in the database which corresponds with the vehicle in the monitored zone, the time at which the vehicle was detected in the monitored zone, the direction of travel of the vehicle in the monitored zone, and two or more of these.

29. A method as claimed in any one of claims 24 to 28 inclusive, which includes accessing or manipulating the database when required.

30. A method as claimed in claim 29, in which the database is accessed or manipulated from a location remote from the database.

31. A method as claimed in claim 29 or claim 30, in which the database is accessed or manipulated over a communication path or protocol selected from the group consisting of a local area network (LAN), a digital cellular network data link, a digital cellular network Short Message Service, a radio frequency link, an earth-orbiting satellite link, and two or more of these.

32. A method as claimed in any one of claims 24 to 31 inclusive, in which the vehicle in the monitored zone is travelling at a speed of more than 100 km/h.

33. A method as claimed in any one of claims 24 to 32 inclusive, which includes capturing the optical image of the monitored zone only when a vehicle is present in the monitored zone and each time a vehicle is present in the monitored zone.

34. A method as claimed in any one of claims 24 to 33 inclusive, which includes illuminating a vehicle in the monitored zone with light in the spectral range of 800 nm to 950 nm.

35. A method as claimed in any one of claims 24 to 34 inclusive, which includes identifying a region of the captured optical image where the registration number is most likely to be located and performing an optical character recognition operation only on said region of the captured optical image.

36. A method as claimed in any one of claims 24 to 35 inclusive, which includes processing the captured optical image to obtain an image more suitable for a character recognition operation, prior to performing an optical character recognition operation to recognize the captured vehicle registration number.

37. A system for locating a vehicle with a particular vehicle registration number, the system including
at least one detection device as claimed in any one of claims 1 to 23 inclusive; and
at least one monitoring station for monitoring alarm signals from the detection device.

38. A system as claimed in claim 37, which includes a plurality of detection devices and in which each detection device is located at a different location than all the other detection devices.

39. A system as claimed in claim 37 or claim 38, in which the or each monitoring station includes transmitting means for transmitting data to the or each detection device.

40. A system as claimed in claim 39, in which the transmitting means is configured to transmit data to the or each detection device over a communication path or protocol selected from the group consisting of a local area network (LAN), a digital cellular network data link, a digital cellular network Short Message Service, a radio frequency link, an earth-orbiting satellite link, and two or more of these.

41. A system as claimed in any one of claims 37 to 40 inclusive, which includes one or more mobile reaction units which can respond to instructions from the monitoring station, or on direct receipt of an alarm signal from a detection device.

42. A detection device as claimed in claim 1, substantialy as herein described and illustrated.

43. A method as claimed in claim 24, substantially as hrein described and illustrated.

44. A system as claimed in claim 37, substantially as herein described and illustrated.

45. A new detection device, a new method of detecting a vehicle with a particular vehicle registration number, or a new system, substantially as herein described.
